(19) United States
(12) Patent Application Publication
(10) Pub. No.: US 2009/0140007 A1
(43) Pub. Date: Jun. 4, 2009

(54) Device and method for blending a binder and a hardener component for producing a ready-made filler

(76) Inventor: Klaus-W. Voss, Uetersen (DE)

Correspondence Address: FRIEDRICH KUEFFNER, 317 MADISON AVENUE, SUITE 910, NEW YORK, NY, 10017, US

(21) Appl. No.: 10/586,984

(22) PCT Filed: Feb. 24, 2006
(86) PCT No.: PCT/EP06/01710

§ 371 Date: Jun. 30, 2008

(30) Foreign Application Priority Data
Feb. 25, 2005 (DE) 102005009220.9
Apr. 11, 2005 (DE) 202005005833.5

(51) Int. Cl. B67D 5/52; B67D 5/60; B65D 88/54; G01F 11/00

(52) U.S. Cl. 222/135; 222/145.6; 222/145.7; 222/1; 222/137; 222/390; 222/333

(57) ABSTRACT

A device for blending a binder component (A) and a hardener component (B) to a pasty or liquid material to be mixed, in particular for producing a ready-made filler for the filling of surfaces of vehicle bodies, has store tanks (3a, 3b) for the separate storage of the components (A, B) which are filled with the components (A or B). The store tanks (3a, 3b) are connected with at least one mixing chamber by separate supplying channels (13a, 13b). The mixing chamber has at least one delivery opening (21) for the material to be mixed. A metering device is provided for the delivery of the components (A, B) out of the store tanks (3a, 3b) through the mixing chamber to the delivery opening (21). The hardener component (B) is placed in at least one store tank (3b) which is connected with the mixing chamber by separate supplying channels (13b), whereby the supply of the binder component (A) and of the hardener component (B) to the mixing chamber takes place by means of control devices in such a manner that the hardener component (B) is supplied to the mixing chamber with a slight advance with respect to the binder component (A).

This invention relates to a device and a method for blending a binder component and a hardener component to a ready-made filler according to the preamble of claim 1.

Such a device for producing a ready-made filler for the filling of surfaces of vehicles bodies is known from the DE 203 07 518 U1. The device has two store tanks placed on a base station, one of which is filled with a binder component, namely a filler component and the other with a hardener component. Both components are respectively continuously fed by means of a metering device to a mixing chamber in which the components come into contact with each other. The mixing chamber is formed in a hose section of a flexible hose on which press rollers are applied on the outside which compress the hose section and simultaneously drive it rotating around its longitudinal axis. The components are blend together by the friction which takes place and the adhesion of the components on the inner wall of the hose. After the material to be mixed has passed the hose section, it arrives to an outlet opening provided on the hose where it continuously comes out of the hose. The hose wall is made of an air-tight synthetic material so that the air surrounding the hose cannot arrive during the mixing process into the material to be mixed and cannot be included therein in form of pores or bubbles. However it has shown in practice that the filler mixed with the device occasionally still has inhomogeneities. If the filler is filled on the surface of a vehicle body, the filler does not cure at the spots where there is no hardener component. The elimination of such defects is related to a relative great expenditure since the filler must be removed by grinding the body and then the body must be filled again. If such defects remain unnoticed during a repair and the body is then lacquered, it is even necessary to lacquer again the spot. If such a defect only appears once for an user, this can result in that the user judges the device as being unreliable and then does not use it any longer.

Therefore the aim is to create a device of the a.m. type which makes it possible to blend all the components with each other so that the material to be mixed cures reliably and completely and that a filler without inclusions of air is obtained.

This aim is achieved with a device with the characteristics indicated in claim 1 and with a method with the method steps indicated in claim 25.

Accordingly the invention consists for a device according to the type in that the device for the hardener component has at least one store tank which is connected with the mixing chamber by at least one, preferably by at least one or two separate supplying channels, whereby the supply of the binder component and of the hardener component to the mixing chamber takes place by means of control devices in such a manner that the hardener component is supplied to the mixing chamber with a slight advance with respect to the binder component.

The method according to the invention consists in that the binder component and the hardener component are supplied to a mixing chamber by intercalating a metering device or by excluding a metering device, mixing chamber to which the hardener component is supplied with an advance with respect to the binder component.

The invention is based on the knowledge that inhomogeneities in the material to be mixed are generally caused by inclusions of air in the hardener component which cannot be surely avoided in practice even with a careful production of the hardener component. Since the hardener component has a percent of less than 5% and preferably of only approximately 2% of the whole volume of the material to be mixed, already the slightest inclusions of air in the hardener component result in that there are spots in the material to be mixed which do not contain any hardener component and thus do not cure. Since for the device according to the invention preferably two store tanks are provided for the hardener component and are connected with the mixing chamber by separate supplying channels, for the case that an air bubble would be once contained in one of the supplying channels normally some hardener component can still be supplied further to the mixing chamber by at least one other supplying channel. The risk that air bubbles would be simultaneously contained in all the supplying channels is very low and can be neglected. The device can be used in particular for the binding agent systems listed below:
polyester resins (unsaturated),
styrene peroxide systems
epoxy resins (system with two components)
polyurethane resin systems (system with two components)
phenolic resin systems (system with two components)
silicone systems (system with two components)
acrylate systems (system with two components)
thiocoll systems (polydisulfide systems).

The device can also work with at least one store tank for the hardener component. If only one store tank is used for the hardener component, the hardener component can be supplied to the mixing chamber by one supplying channel. However it is also possible to supply the hardener component by at least two supplying channels. If more than one store tank is used for the hardener component, each store tank is connected with the mixing chamber by a supplying channel.

Furthermore, a particular advantage consists in that the hardener component is supplied to the mixing chamber with an advance. It has namely shown that for a simultaneous supply of the binder component and of the hardener component the binder component arrives into the mixing chamber before the hardener component is in the mixing chamber. This uneven component supply to the mixing chamber is based on that a bigger quantity of binder component is required compared to the quantity of hardener component used for the production of the filler and that thus, when the device is set into operation, the first part of the binder component which arrives into the mixing chamber does not find yet any hardener component so that the filler which leaves the mixing chamber, i.e. the material to be mixed, has parts to which no hardener component is mixed. This disadvantage is avoided in that the hardener component is supplied to the mixing chamber with a slight advance by means of a corresponding control of the hydraulically or electromotively driven sliding bottoms for pressing out the components out of the store tanks. This advance of the hardener component with respect to the binder component can also be achieved with additional devices, namely by a preliminary injection of the hardener component to the binder component by means of a hydraulically, pneumatically or electromotively driven piston which presses a part of the supplied hardener component in advance into the mixing chamber before the supply of the binder component into the mixing chamber takes place so that the supplied binder component already meets the hardener component existing in the mixing chamber.

With the advance according to the invention of the hardener component to the binder component, the following advantage is achieved. If the hardener component would come into the mixing chamber simultaneously with the binder component, excellent mixing results would be achieved. But since the hardener component participates only with a quantity of 2% to the whole mass, it cannot be avoided that the hardener component comes only at a later time, for example one second later, into the mixing chamber, than the binder component with a percentage of 98% of the whole mass. But in this one second already approximately 10 grams of binder component already arrived in the mixing chamber in which there is not yet any hardener component. This binder component percentage pushes itself now through the mixing chamber and comes out of the outlet opening thereof and can not cure because of lacking hardener component. If some of this mass is applied onto the body of a vehicle, the lacquerer notices this only when the applied mass will be ground. The solution of this problem according to the invention is such that, before the big quantity of hardener component comes into the mixing chamber, a quantity of hardener component is already in the mixing chamber so that a blending with the hardener component takes place from the beginning. For this purpose, an embodiment of the invention provides that a small quantity of hardener component, for example of approximately 0.2 gram, is injected into the mixing chamber by means of a small piston driven by compressed air before the big quantity of 98% of binder component arrives into the mixing chamber. In this manner it is guaranteed that all the binder component supplied to the mixing chamber is mixed with the hardener component and thus that the filler obtained contains some hardener component, at least in a quantity of 1% which is required for a suitable curing.

This preliminary injection or supply of a small quantity of hardener component is particularly advantageous. Even if the hardener component is coloured, the quantity of colour is so small because of the only 2% addition of hardener component that it cannot be seen in a ready mixed filler if it contains hardener component or not. With the preliminary injection it is guaranteed that curable fillers are obtained in all parts.

Advantageous configurations of the invention are the subject of the subclaims.

In a preferred embodiment of the invention, the metering device is configured in such a way that with a bubble free mixing of the components the mixing ratio V_{B}:V_{S} from the volume flow V_{B} of the hardener component supplied to the mixing chamber and the sum V_{S} of the volume flow V_{B} and the volume flow V_{A} of the binder component supplied to the mixing chamber is in the range of the 1% to 4%, in particular between 1.5% and 3% and preferably approximately 2%. The device is thus designed in such a way that the mixing ratio for a polyester filler and bubble free mixing of the components has a low potlife and a low consumption of the hardener component. Should once an air bubble be contained in one of the supplying channels for the hardener component, the mixing ratio is reduced compared to the mixing ratio for a bubble free blending so that the time which the material to be mixed requires for curing is prolongated correspondingly. The material to be mixed also cures in this case.

It is advantageous when a thixotrope binder component is placed in the store tank for the binder component and when the device has a device placed before the mixing chamber for increasing the flowability of the binder component. For the supply of the binder component to the mixing chamber, the thixotropy of the binder component is then provisionally reversibly destroyed so that the hardener component is better distributed in the binder component, in particular if an air bubble would be once placed in one of the supplying channels for the hardener component and thus only a correspondingly reduced quantity of hardener component can be supplied to the mixing chamber. For a polyester filler the difference between the hardener component and the binder component in the material to be mixed must be clearly lower than 0.5 millimeter so that an uniform hardening of the material to be mixed is obtained and that there does not remain any area in the material to be mixed in which no hardening takes place. Due to the device for increasing the flowability, the feed pressure required for the supply of the binder component to the mixing chamber is reduced, in particular for low temperatures which are often situated in winter time below 12° C. in a repair shop.

For an appropriate embodiment of the invention, the device for increasing the flowability has at least one element placed in the supplying channel for the binder component which can be driven in such a way that kinetic energy is brought into the binder component. Due to the bringing in of kinetic energy the thixotropy of the binder component is reversibly attenuated or even completely eliminated.

It is particularly advantageous if the store tanks are placed on a base station when the mixing chamber is formed in a mixing head which can be detachably connected with the base station and when the supplying channels are guided and the mixing head configured in such a manner that after the mixing process is terminated and the mixing head separated from the base station all the rests of the material to be mixed remain in the mixing head. This being, the mixing head is configured as throw-away part which is separated form the base station after the mixing process is terminated and is evacuated together with the rest of material to be mixed which remains therein. Since the components are in contact with each other only in the mixing head, there do not remain any hardened rests of material to be mixed on the base station. Thus the base station can be equipped in a simple manner with a new mixing head after a mixing process has been terminated and is then be immediately ready for use for a further mixing process. When the device on the base station has a device for the flowability of the binder component, the cross section of a supplying channel connecting the store tank for the binder component with the mixing head can be chosen small at least at the transition between the base station and the mixing head so that, when the mixing head is pulled off the base station, the binder component gets of without later dropping. Moreover due to the element bringing in the kinetic energy into the binder component, when the mixing head is pulled off, the tear-off point of the binder component is offset to the element bringing in the kinetic energy so that the tip of the bead which is formed on the base station when pulling off the mixing head is correspondingly short and the insertion of the new mixing head is facilitated.

Appropriately the supplying channel for the binder component has an inner and an outer limiting wall which are spaced from each other by an annular gap and are movable with respect to each other in circumferential direction of the annular gap, whereby at least one of these limiting walls as element for bringing in the kinetic energy has a projecting part. Thus the device enables an easy and economical assembly. The limiting wall which has the projecting part is preferably movable with respect to the store tank for the binder component and is drivable.

It is advantageous if at least the outer limiting wall is made of a transparent material and if the hardener component differs from the binder component preferably by its colour. The mixing process can then be optically controlled through the outer limiting wall by means of the colour of the material to be mixed.

The elements for bringing in kinetic energy can be placed in several levels spaced from each other in direction of the rotational axis of the motion of revolution by gaps. This being, it is even possible that the planes of extension of at least two levels with elements for bringing in kinetic energy are tilted to each other. Thus, a still better preliminary fluidization of the binder component is enabled.

For a preferred embodiment of the invention, the metering device is configured in such a manner that for a bubble free hardener component the quantity of hardener component supplied to the mixing chamber is drawn approximately in equal quantities from the single store tanks for the hardener component. Thus, when an air bubble appears in one of the supplying channels independently from the supplying channel in which the air bubble is, approximately always the same quantity of hardener component comes into the mixing chamber.

Appropriately the store tank for the binder component is preferably placed approximately in the middle between the store tanks for the hardener component. The base station can then have a symmetrical structure.

Preferably the store tanks are configured respectively as cartridges with a sliding bottom displaceable in a hollow cylindrical housing section, whereby respectively a seat with an abutment for the hollow cylindrical housing section is provided on the base station for each cartridge and whereby a pressure piston is positioned adjustable respectively to the abutment with which a pressure can be charged onto the sliding bottom of the concerned cartridge for pressing out the component which is therein. If the components which are in the store tanks are used up, the base station can be refilled in a simple way by replacing the cartridges.

It is advantageous if the pressure pistons are connected by a bridge with each other preferably at their end areas away from the sliding bottoms and if the bridge is movable with respect to the abutments by means of an actuator. The components can thus be supplied to the mixing head in a simple manner in a volume flow ratio predetermined by the ratio of the bases of the sliding bottoms of the cartridges. Thus a correct metering of the components is always guaranteed.

The actuator can have a drive shaft which is connected with the bridge for displacing the bridge over a spindle nut placed on a threaded spindle. This being, the motion of rotation of the drive shaft is converted into a translation movement required for the adjusting of the cartridge sliding bottoms.

For an advantageous configuration of the invention, the actuator has an electric motor, whereby an accumulator is preferably provided for the current supply of the electric motor. The device can then be motor-driven without an external energy supply. The electric drive formed by the electric motor and the accumulator can be a commercial drive for an accumulator drilling machine.

For another advantageous embodiment of the invention, the actuator has a pneumatic or a hydraulic working cylinder and/or a pneumatic or hydraulic motor. The device is then appropriate for an use in potentially explosive rooms.

The drive shaft can also be drivingly connected with a handwheel. The metering device can then be manually driven without external energy supply.

It is advantageous if the drive shaft is drivingly connected with at least one mixing element placed in the mixing chamber. A driving device connected with the drive shaft can then drive the metering device as well as the mixing element. This being, the speed with which the sliding bottoms are moved is proportional to the number of revolutions of the mixing element so that a good thorough blending of the components is always achieved practically independently from the number of revolutions of the drive shaft. Moreover the device enables an easy and economical assembly.

In a preferred embodiment of the invention, the mixing chamber is formed in the type of an annular gap between an inner and an outer chamber wall, whereby the chamber walls are positioned rotatable to each other about a rotational axis, whereby the mixing elements are teeth placed on the sides of the chamber walls which are turned to each other, teeth to which tooth spaces are adjacent in circumferential direction of the mixing chamber and whereby the teeth during the motion of rotation rotate past each other by being offset to each other in direction of the rotational axis in such a manner that the components are mixed with each other by division. The cooperating teeth of the outer and inner chamber walls enauble a thorough blending of the components. This being, shearing forces are brought by the teeth into the components or the material to be mixed which cause that the partial areas of the components or of the material to be mixed which are in the tooth spaces are cut off of adjacent partial areas in direction of the rotational axis and are offset or displaced in direction of the motion of rotation. Simultaneously new component material is continuously supplied to the mixing chamber by the supplying channels so that a current develops which runs from the supplying channels to the outlet opening. In this manner new component material and/or material to be mixed comes continuously into the range of action of the teeth. Contrary to a hose mixer, the chamber walls of the mixing chamber are preferably configured resistant to bending in such a manner that they substantially keep their shape during the shearing forces action of the components or of the material to be mixed.

In a preferred embodiment of the invention, it is provided that the inner chamber wall and the outer chamber wall are positioned twistable to each other with an axial backlash, that the teeth of the inner chamber wall are offset to the teeth of the outer chamber wall in axial direction in such a manner that front side faces turned to each other, orientated in axial direction, of at least one tooth of the inner chamber wall and of at least one tooth of the outer chamber wall can be positioned against each other by a force acting in axial direction between the inner chamber wall and the outer chamber wall and that these front side faces are inclined with reference to a surface plane placed normal to the rotational axis with an angle such that the front side faces glide on each other during the mixing process without material being removed from the teeth into the material to be mixed. It is thus possible to maintain the length of the mixing head short in direction of the rotational axis so that after having used the mixing head only a correspondingly small residual quantity of the mixture remains in the mixing head. the device thus enables a low consumption of the components. During the mixing process the teeth of the inner chamber wall and the teeth of the outer chamber wall are pressed against each other by the feed pressure of the components, whereby the front side faces oblique to each other glide on each other without material being removed by abrasion by the teeth and coming into the material to the mixed. This being the components and/or the material between the front side faces gliding on each other form a thin film which acts as a gliding layer. The angle under which the teeth are inclined with respect to the surface plane placed normal to the rotational axis can be at least 5°, eventually at least 10° and preferably at least 15°. It should be mentioned that a mixing head with such chamfered teeth can also be provided for a device which has respectively only one single store tank for each component. Such a device is described in the german patent application 10 2004 044 625.3.

Additionally to the first electric motor the device can have a second electric motor drivingly connected with at least one mixing element, whereby the electric motors are preferably connected with a control device which is configured in such a way that the first electric motor is switched on when switching on or with a time delay after the second electric motor has been switched on. This being, it is even possible that the device has a contact maker over which the second electric motor is automatically switched on when the mixing head is positioned on the base station.

For the centering of the outlet openings configured in the tank bottom of each store tank for the binder component and for the hardener component for the supply of the tank content to the inlet openings of the supplying channels, a ring-shaped or partially ring-shaped outwards orientated bead is configured in the tank bottom plate, bead which engages into corresponding groove shaped recesses in the abutment configured in the type of a carrier plate for the store tanks, whereby the beads and the groove shaped recesses corresponding with them are configured to each other in such a manner that each store tank bears plainly on the abutment.

A further embodiment of a conformation for the centering of the store tanks provides that each store tank for the binder component and the hardener component for centering the outlet opening configured in the tank bottom for the container content to the inlet openings of the supplying channels with its bottom sided peripheral marginal bead can engage into a ring groove corresponding with this bead and configured in the carrier plate abutment, whereby the peripheral marginal bead of the store tank with the ring groove in the abutment are configured to each other so that the store tank plainly bears on the abutment.

Embodiments of the invention will be explained in more detail by means of the drawings.

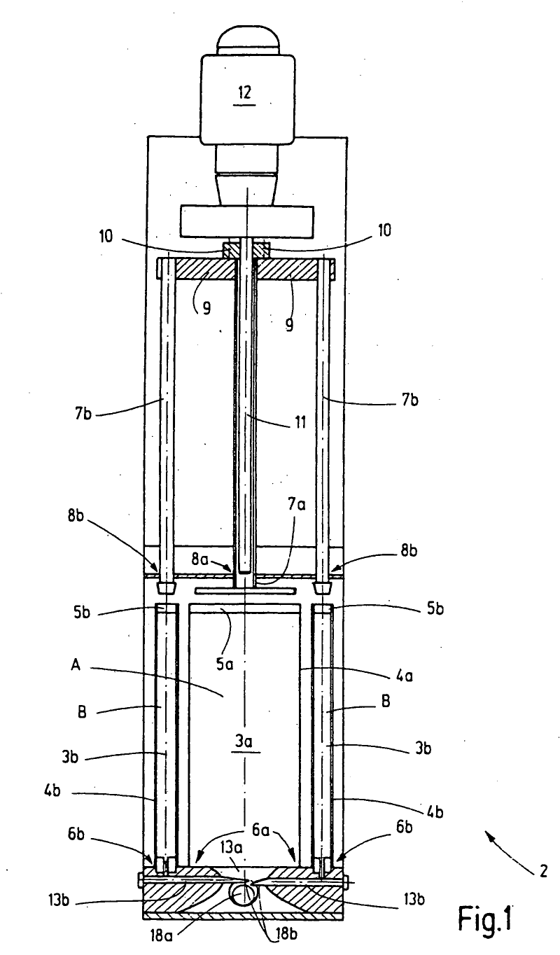

FIG. 1 shows partly in a view, partly in a vertical section a base station of the device for blending a binder component with a hardener component.

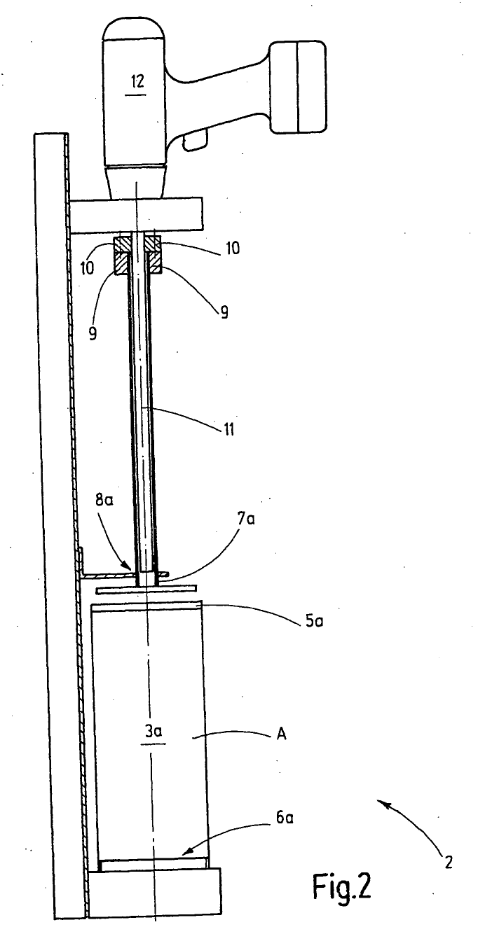

FIG. 2 shows a side view of the device according to FIG. 1, partly in a vertical section.

FIG. 2A shows in a schematical representation the supply of the binder component and of the hardener component into the mixing chamber of the device.

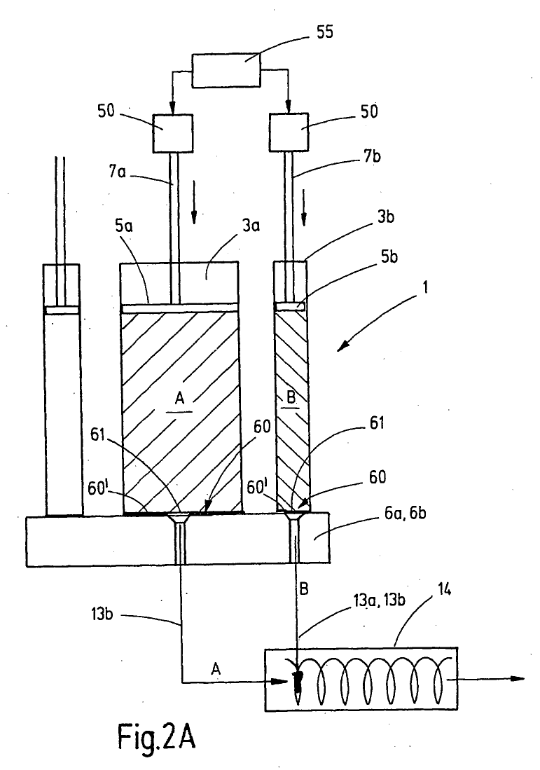

FIG. 3 shows a top view of a stator part of a mixing head.

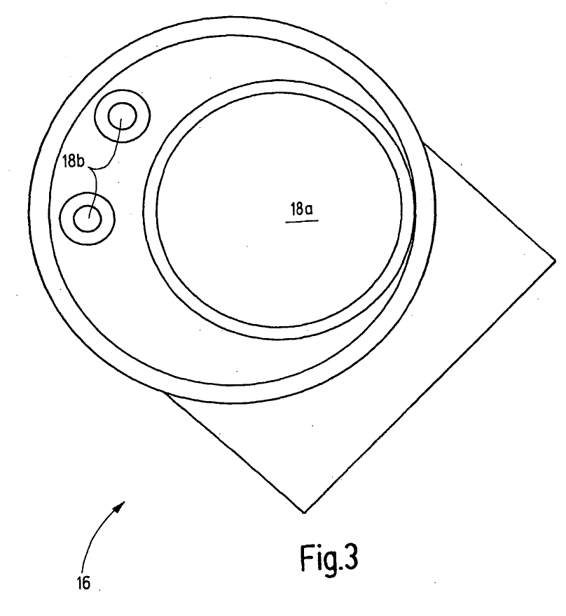

FIG. 4 shows a side view of the mixing head, whereby the stator part is represented in section.

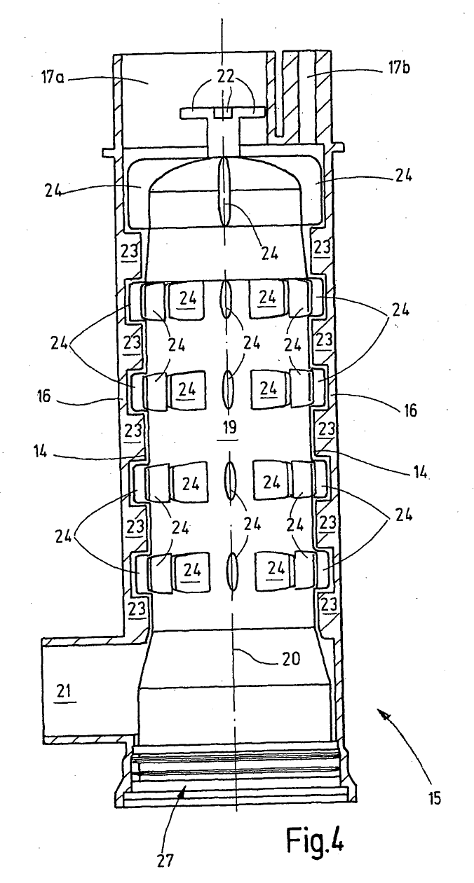

FIG. 5 shows a cross section through the mixing head.

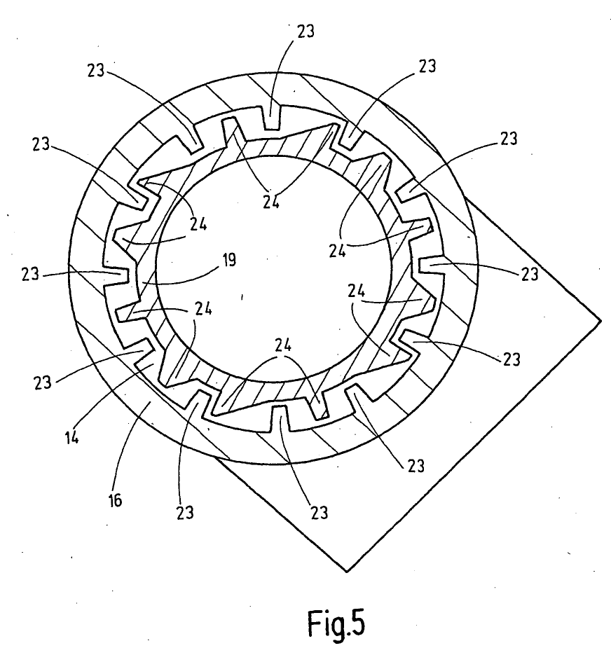

FIG. 6 shows a longitudinal section through the stator part.

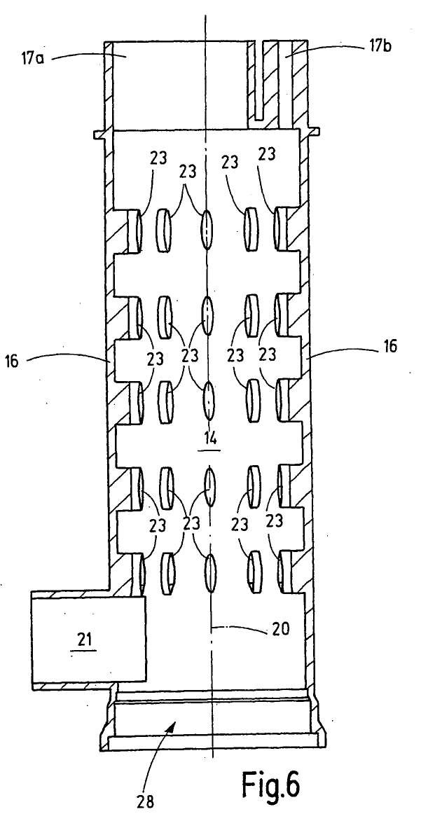

FIG. 7 shows a side view of a rotor part of the mixing head.

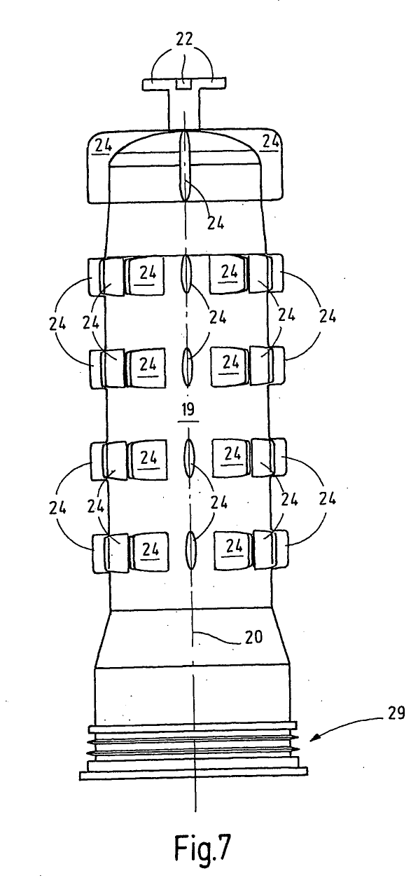

FIG. 8 shows a partial cross section through a mixing head along a ring-shaped circumferential mixing zone, whereby the teeth of the stator part are represented hatched and the teeth of the rotor part not hatched.

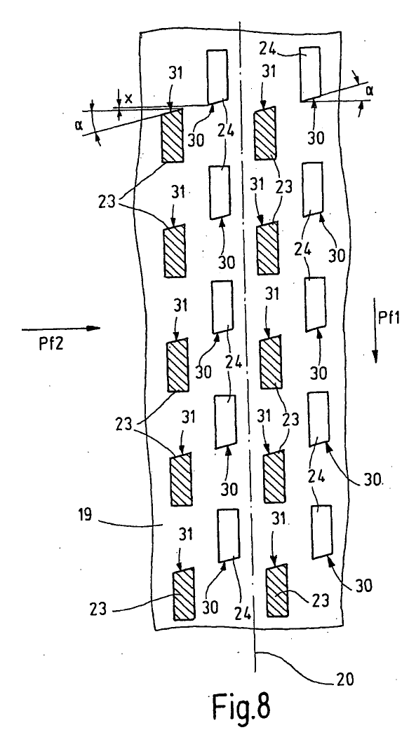

FIG. 9 shows a side view of the mixing device, whereby a mixing head connected with the accumulator driven electric drive is placed on the base station in preassembly position.

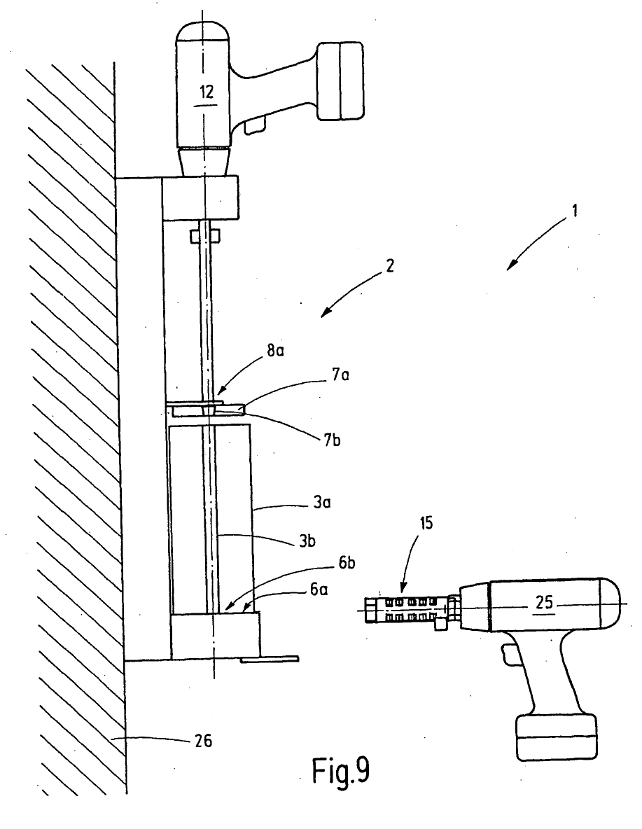

FIG. 10 shows a representation similar to FIG. 9, whereby however the mixing head and the electric drive are placed in position of use.

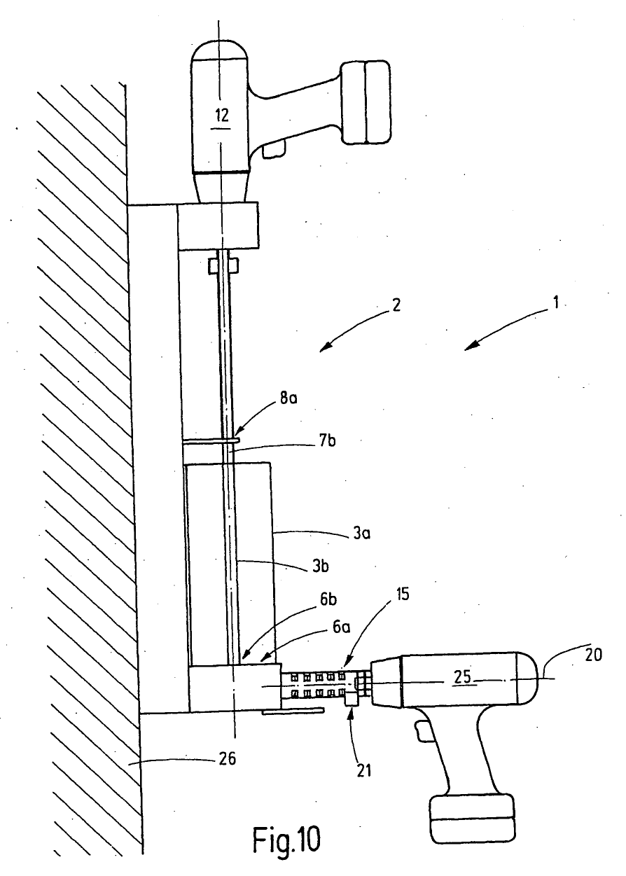

FIG. 11 shows partially in a view and partially in a vertical enlarged section a store tank placed on the carrier plate type configured abutment and on centered thereon.

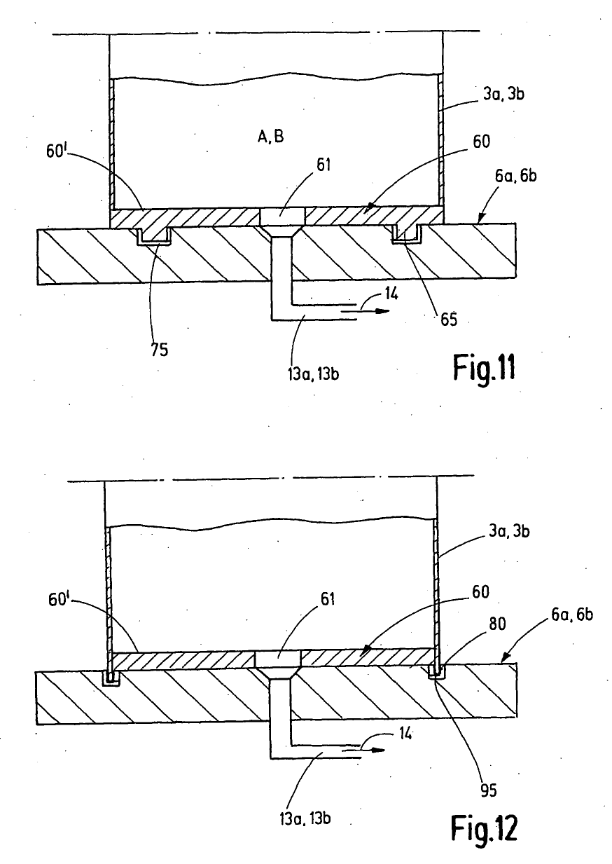

FIG. 12 shows partially in a view and partially in a vertical enlarged section a further embodiment of a store tank placed on the carrier plate type configured abutment and on centered thereon.

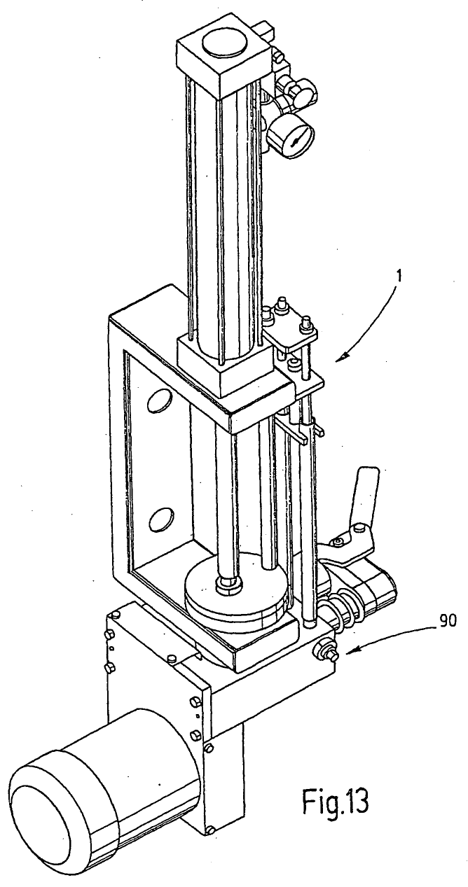

FIG. 13 shows a graphical view of a device for blending a binder component with a hardener component with a device for the preliminary injection of a small quantity of hardener component into the mixing chamber.

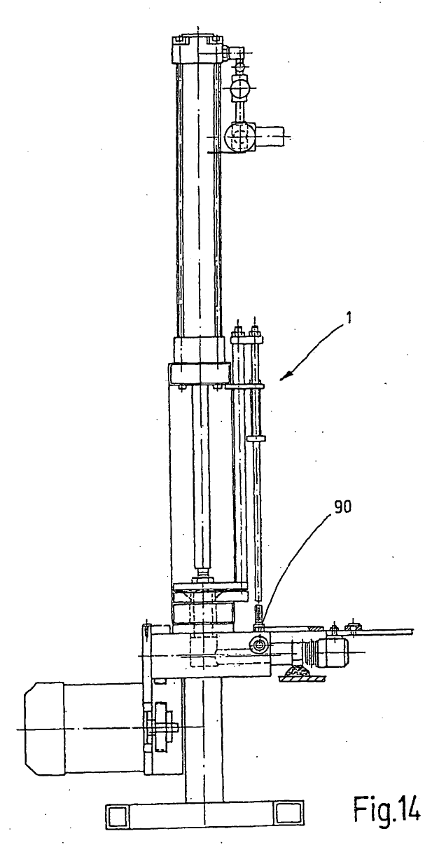

FIG. 14 shows a side view of the device according to FIG. 13.

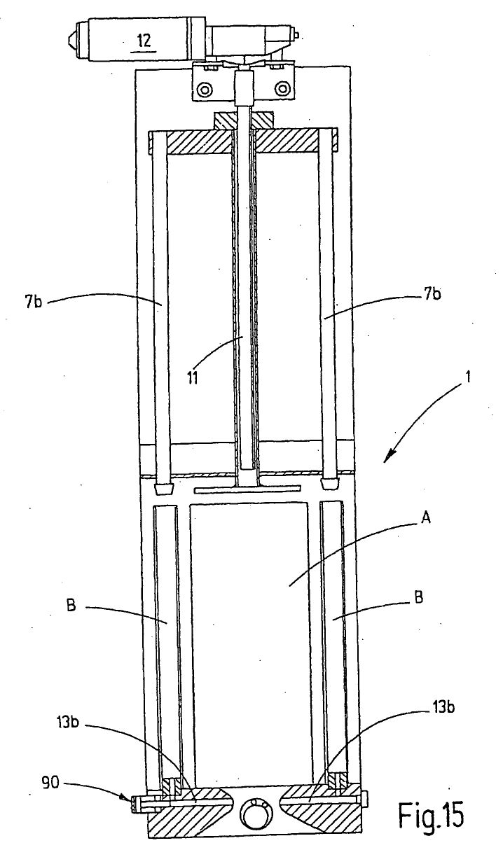

FIG. 15 shows partially in a view and partially in a vertical section a base section of the device for blending a binder component with a hardener component with a device for the preliminary injection of a small quantity of hardener component into the supplying channel for the hardener component to the mixing chamber.

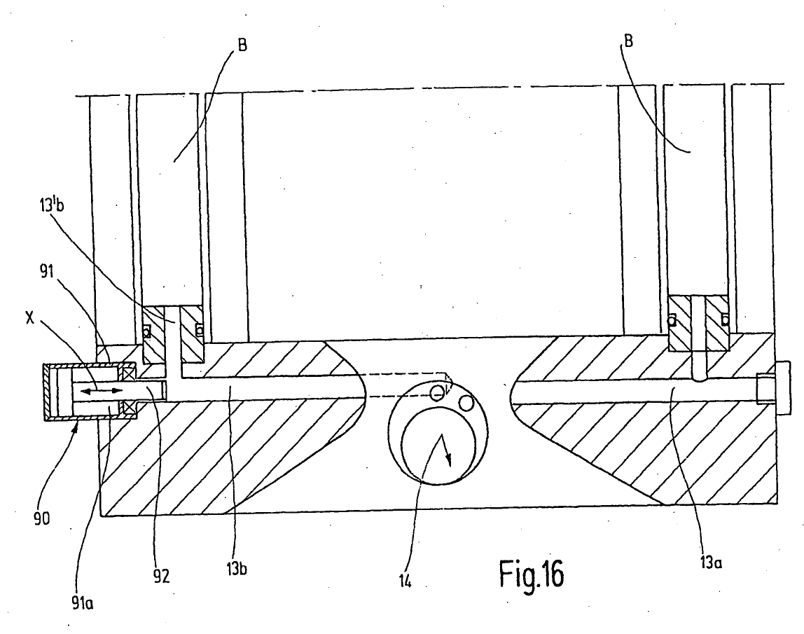

FIG. 16 shows partially in a view and partially in a vertical section a section of the device for blending with the supplying channels for the hardener component to the mixing chamber and with a device connected with one of the two supplying channels for the preliminary injection of a small quantity of hardener component into the mixing chamber, the piston being withdrawn.

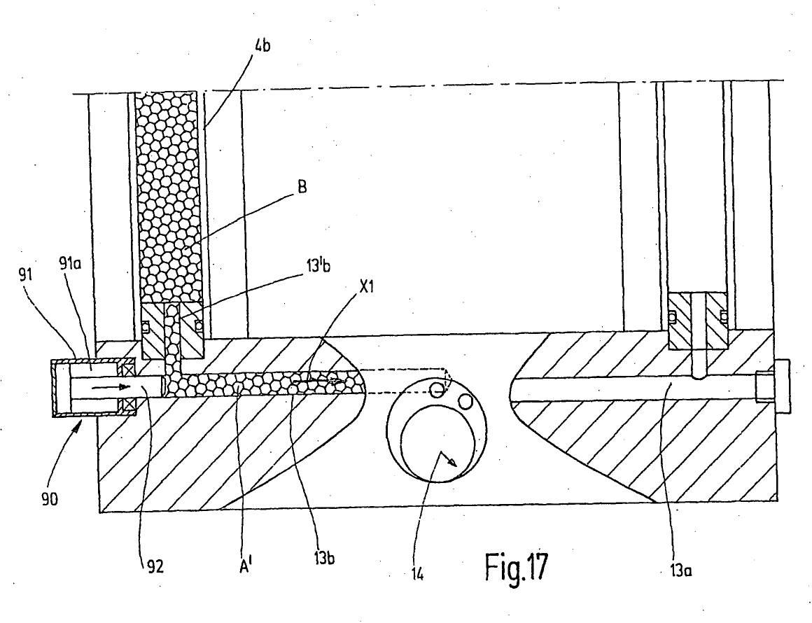

FIG. 17 shows the device according to FIG. 16 with the device for the preliminary injection of the hardener component with the withdrawn piston for introducing a small quantity of hardener component into the mixing chamber, whereby some hardener component is in the supplying channel.

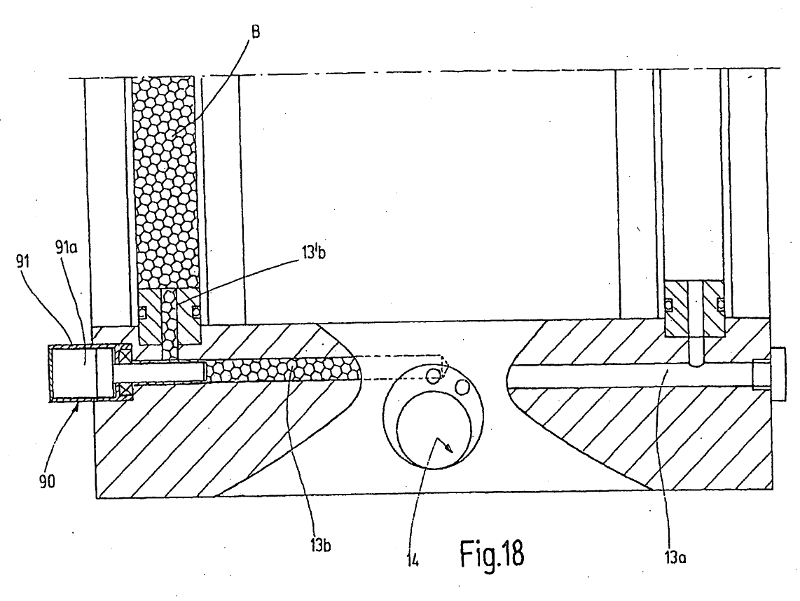

FIG. 18 shows the device with the device for the preliminary injection of the hardener component with the withdrawn piston for the release of the flow of the hardener component to the mixing chamber.

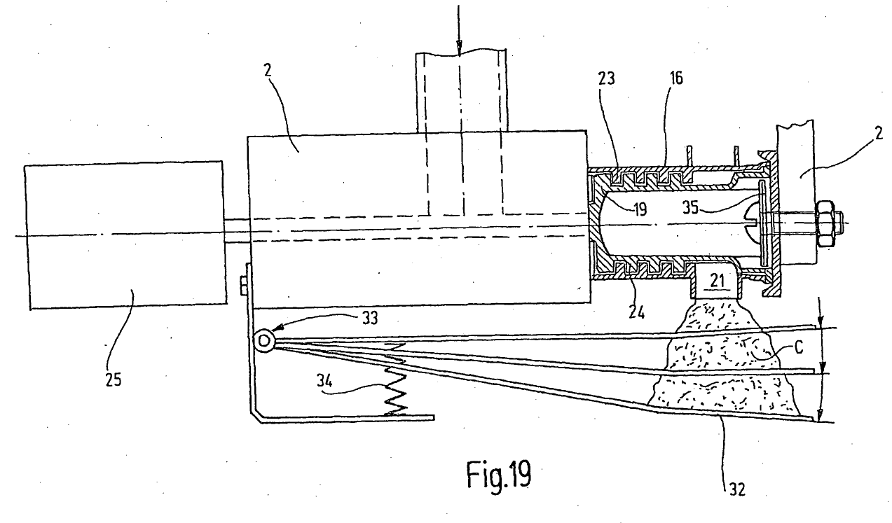

FIG. 19 shows a side view partially represented in longitudinal section of a mixing device which has a receiving element positioned swivellable for the material to be mixed which is represented in three different swivelling positions.

A device designated as a whole by 1 for blending a binder component A and a hardener component B to a ready-made filler for the filling of surfaces of vehicle bodies has a base station 2 on which a first store tank 3a filled with the binder component A such as for example polyester filler and two second store tanks 3b filled with the hardener component B such as for example filled with a peroxide are placed. It can clearly be seen that both store tanks 3b for the hardener component B have respectively a clearly lower cross-section than the store tank 3a for the binder component. The sum of the cross section surfaces of both store tanks 3b for the hardener component B preferably is approximately 2% of the sum of the overall cross-section surface of the three store tanks 3a, 3b. Both store tanks 3b for the hardener component have the same construction.

As it can be recognized in FIG. 1, the store tanks 3a, 3b are respectively configured as cartridges with a sliding bottom 5a, 5b slidable in a hollow cylindrical housing section 4a. The sliding bottoms 5a, 5b bear with their outer edge respectively tightly on the inner wall of the housing section 4a, 4b assigned to them of the concerned cartridge.

A metering device which has for each cartridge respectively a seat for an abutment 6a, 6b for the hollow cylindrical housing section 4a, 4b of the cartridge is placed on the base station 2. The housing section 4a, 4b bears respectively on this abutment 6a, 6b, when the cartridge is inserted in the seat.

For each sliding bottom 5a, 5b, the metering device has respectively a pressure piston 7a, 7b which in position of use attacks on the rear side of the sliding bottom 5a, 5b which is opposite to the component A, B to be pressed out of the cartridge and which is movable to and from the abutment 6a, 6b by means of sliding guide 8a, 8b (FIG. 1 and FIG. 2). It can be recognized in FIG. 1 that the pressure pistons 7a, 7b are placed with their longitudinal axles approximately parallel to each other and that the pressure piston 7a provided for pressing out the binder component A is placed between the two pressure pistons 7b for the hardener component B.

At their end areas remote from the sliding bottoms 5a, 5b the pressure pistons 7a, 7b are fixedly connected with each other by a bridge 9 which extends transversely to the pressure piston 7a, 7b. The bridge 9 is connected resistant to torsion with a spindle nut 10 which is screwed with a threaded spindle 11. The threaded spindle 11 is drivingly connected with the shaft of a first electric motor 12 for charging pressure to the sliding bottoms 5a, 5b, the electric motor being placed on the base station 2 on the side of the bridge 9 opposite to the cartridges approximately in straight prolongation of the pressure piston 7a for the binder component A. A transmission gear can be placed between the shaft and the threaded spindle 11.

It can be recognized in FIG. 1 that the pressure piston 7a for the binder component A is configured as a bush and that the threaded spindle 11 engages into the inner hollow of the bush. At its end turned to the sliding bottoms 5a the pressure piston 7a has a plate-shaped enlargement which is adapted to the shape of the sliding bottom 5a.

The pressure pistons 7a, 7b are controlled by means of hydraulic or electromotive driving gears 50 which are combined in a control device 55 (FIG. 2A).

Preferably the device 1 has a store tank 3a for the binder component A and at least one store tank 3b for the hardener component B. In case of only one store tank 3b for the hardener component B, this tank is connected with the mixing chamber 14 by a supplying channel 13b. It is also possible to connect a sole store tank 3b with the mixing chamber by two separate supplying channels. If two store tanks 3b are used for the hardener component B, the connection with the mixing chamber 14 takes place by two separate supplying channels.

The device 1 for the hardener component B has preferably at least two store tanks 3b which are connected with the mixing chamber 14 by separate supplying channels 13b.

In order to achieve an advance of the hardener component B into the mixing chamber 14 with respect to the binder component A, the drive gears 50 for the pressure pistons 7a, 7b for the sliding bottoms 5a, 5b of the store tanks 3a, 3b for the binder component A and for the hardener component B are controlled by means of the control device 55 in such a manner that the hardener component B is already introduced into the mixing chamber 14 before the binder component A enters the mixing chamber 14 so that the whole quantity of binder component A introduced in the mixing chamber 14 is mixed with the hardener component B (FIG. 2A).

At their end opposite the sliding bottom 5a, 5b, the cartridges have respectively a withdrawal opening for the component A, B stored in the cartridge. Each of the withdrawal openings is respectively connected by a separate supplying channel 12a, 12b with a common mixing chamber 14 which is placed in a mixing head 15 removably connectable with the base station 2. A seal, such as for example an O-ring seal, can be placed between the wall of the supplying channel 12a, 12b and the cylindrical housing section 4a, 4b of the cartridge which is respectively corresponding to the supplying channel 12a, 12b.

It can be recognized in FIG. 3 that the mixing head has a stator part 16 which has a first inlet opening 17a for the binder component A and two second inlet openings 17b for the hardener component B. A first outlet opening 18a corresponds to the first inlet opening 17a on the base station 2, this outlet opening being connected with the first store tank 3a by a first supplying channel 12a. A second outlet opening 18b is respectively assigned on the base station to the second inlet openings 17b, this outlet opening being respectively connected by a second supplying channel 12b with a second store tank 3b assigned to the concerned inlet opening 17b. When the mixing head 15 is connected to the base station, the first outlet opening 18a of the first inlet opening 17a and the second outlet openings 18a are turned respectively to a second inlet opening 17b so that the components which are in the single cartridges can arrive to the mixing head 15 by ways which are separate from each other. Thus, for the case that an air bubble would once be in one of the supplying channels 12b for the hardener component B, some hardener component B can be guided into the mixing chamber 14 over the other supplying channel 12b.

The connecting of the mixing head 15 with the base station 2 is made by plugging the inlet openings 17a, 17b onto the outlet openings 18a, 18b. For this purpose, the inlet openings 17a, 17b and the outlet openings 18a, 18b are configured as plug-in coupling parts which are sealingly connected with each other in connection position.

It can be recognized in FIG. 4 that a rotor part 19 is placed rotatable in the stator part 16 of the mixing head 15. A device for increasing the flowability of the thixotrope binder component A is placed on the rotor part 19 between the first inlet opening 17a for the binder component A and the mixing chamber 14, this device having on the rotor part 19 several projections 22 projecting approximately radially to the longitudinal axis 20 in different directions which rotate together with the rotor part 19 about the longitudinal axis 20 when the rotor part 19 is rotatably driven with respect to the stator part 16. Kinetic energy is brought into the binder component A by these projections 22 in order to reversibly destroy the thixotropy thereof. The binder component A can thus be mixed more uniformly with the hardener component B when entering into the mixing chamber 14.

It can be recognized in FIG. 4 that the components A, B are guided in the mixing head 15 in such a manner that they come into contact with each other only in the inside of the mixing head. So all the rests of material to be mixed remain in the mixing head 15 after the mixing process has been terminated and the mixing head 15 is separated from the base station 2. The mixing head is configured as a throw-away part which is evacuated after use and replaced by a corresponding new part.

The mixing chamber 14 is formed between the stator part 16 and the rotor part 19. It can be clearly recognized in FIG. 5 that the mixing chamber 14 is configured with the shape of an annular gap between an inner chamber wall placed on the rotor part 19 and an outer chamber wall provided on the stator part 16. The material to be mixed can be continuously fed through the mixing chamber 14 to a delivery opening 21 placed on the stator part 16, this delivery opening being placed in flow direction behind the inlet openings 17a, 17b.

It can be recognized in FIG. 4 to FIG. 7 that the opposed chamber walls of the mixing chamber 14 have teeth 23, 24 as mixing elements. The inner chamber wall placed on the rotor part 19 and the outer chamber wall 8 provided on the stator part 16 have respectively several levels spaced from each other in direction of the longitudinal axis 20 with teeth 23, 24. The teeth 23, 24 of the single levels are spaced from each other respectively in circumferential direction of the mixing chamber 14 by tooth spaces. The chamber walls have respectively gaps between the single levels through which during the movement of rotation the teeth 23, 24 of the respectively other chamber wall which are opposed to the concerned gap pass. This being due to the continuous supply of the components A, B to the mixing chamber 14 it comes to a division of the flow of material to be mixed, i.e. one part of the flow of the material to be mixed passes respectively along the one side of the concerned tooth 23, 24 and the other part on the other side of the concerned tooth 23, 24. Since this division takes place in several steps corresponding to the number of the levels, the material to be mixed is mixed thoroughly.

The rotor part 19 and the stator part 16 are positioned rotatable to each other by means of a sliding bearing 27. The sliding bearing 27 has an outer bearing ring 28 on the stator part 16 and an inner bearing ring 29 on the rotor part 19 which are supported against each other in radial and axial direction. The sliding bearing 27 has axial clearance in direction of the longitudinal axis 20 so that the teeth 24 of the rotor part 19 are slightly moved with their front side faces 30 turned against the main flow direction of the components A, B or of the mixture indicated by the arrow P2 to the front side faces 31 of the teeth 23 of the stator part 16 turned respectively to these faces, orientated in main flow direction Pf2 when the mixing head 15 is charged with the feed pressure of the components A, B.

It can be recognized in FIG. 8 that the front side faces 28, 29 are inclined with respect to a surface plane placed normally to the longitudinal axis 20 by an angle α in such a way that they can glide onto each other during the mixing process. This being, a thin layer of the material to be mixed which serves as a gliding film is placed between the front side faces 28, 29 of the teeth 23, 24 respectively cooperating with each other. The ends of the front side faces 28, 29 turned to each other of the rotor teeth 24 and of the stator teeth 23 are thus slightly spaced from each other in longitudinal direction of the mixing head 15. In FIG. 8 the corresponding space is designated by x. Due to the inclined position of the front side faces 28, 29, it is avoided during the mixing process that material is removed from the teeth 23, 24 and comes into the material to be mixed C. The axial length of the rotor teeth 24 is only slightly shorter than the inner width of the gaps between the levels of the teeth 23 of the stator part 16. Thus the mixing head 15 enables a short construction. It should still be mentioned that the forward direction of rotation of the rotor part 19 is marked in FIG. 8 by an arrow Pf2.

For the embodiments shown in FIGS. 9 and 10, the base station 2 is fixed on a wall 26 of a building. Additionally to the first electric motor 12 driving the threaded spindle 11, a second electric motor 25 is provided which is drivingly connected with the rotor part 19 of the mixing head. The second electric motor 25 has a catch which can be put positively fitting onto the rotor part 19. For actuating the device, first the mixing head 15 is put onto the catch and then the mixing head 15 with the inlet openings 17a, 17b is put onto the outlet openings 18a, 18b of the base station 2. This being, a switching device which is not represented in the drawings is actuated which connects the electric motors 12, 25 with a current supply and thus starts the mixing process.

The device 1 for mixing a binder component A and the hardener component B to a pasty or liquid material to be mixed, in particular for producing a ready-made filler for the filling of surfaces of vehicle bodies thus has store tanks 3a, 3b for the separate storage of the components A, B which are filled with the components A and B. The store tanks 3a,3b are connected by separate supplying channels 13a, 13b with at least one mixing chamber 14. The mixing chamber 14 has at least one delivery opening 21 for the material to be mixed. A metering device is provided for delivering the components A, B from the store tanks 3a, 3b through the mixing chamber 14 to the delivery opening 21. The hardener component B is placed in at least two store tanks 3b which are connected with the mixing chamber by separate supplying channels 13b.

According to FIG. 11, each store tank 3a, 3b for the binder component A and for the hardener component B has for centering the outlet opening 61 configured in the tank bottom 60 for the tank content to the inlet openings of the supplying channels 13a, 13b ring-shaped or partially ring-shaped beads 65, orientated outwards in or on its bottom plate 60′ which engage into corresponding groove-shaped recesses 75 in the carrier plate configured abutment 6a, 6b for the store tanks 3a, 3b, whereby the beads 65 and the groove-shaped recesses 75 which correspond to them are configured in such a manner that each of the store tanks 3a, 3b bears with its tank bottom 60 plainly on the abutment 6a, 6b. If the outlet opening 61 in the bottom plate 60′ of the store tank 3a, 3b is configured as a bent orientated outwards, the inlet opening of each supplying channel 13a or 13b has corresponding recesses so that the plain bearing of the store tank 30a, 30b on the abutment 6a, 6b is guaranteed.

FIG. 12 shows a further embodiment for which each store tank 3a, 3b for the binder component A and for the hardener component B can engage for centering the outlet opening 61 configured in the tank bottom 60 for the container content to the inlet openings of the supplying channels 13a, 13b with its bottom-sided peripheral edge bead 80 or its peripheral edge border into a ring groove 95 corresponding with this border and configured in the carrier plate abutment 6a, 6b, whereby the peripheral edge bead 80 of the store tank 3a, 3b and the ring groove 95 are configured in the abutment 6a, 6b in such a manner that the store tank 3a, 3b bears with its bottom plate 60′ plainly on the abutment.

The above described device 1 for mixing the binder component A with a hardener component B is provided according to FIGS. 13 and 14 with a device 90 for the preliminary injection of a small quantity of hardener component A. Before the binder component A is supplied to the mixing chamber 14 of the device 1, a small quantity of hardener component B is supplied by means of the device 90 to one of the two supplying channels 13a or 13b for the hardener component B to the mixing chamber 14 or directly to the mixing chamber 14.

This device 90 consists of a cylindrical housing in the inner space 91a of which a bar-shaped piston 92 is movable in direction of the arrow Y by means of a pneumatic drive (FIGS. 15, 16, 17 and 18). This being, the arrangement of the device 90 is such that the piston 92 can be moved into the supplying channel 13. The device 90 can also be assigned to the supplying channel 13a. The hardener component B is supplied to the mixing chamber 14 by the two supplying channels 13a, 13b.

The mode of operation and the control of the device 90 is as follows. FIG. 16 shows the starting position of the piston 92 which is withdrawn. In this withdrawn position of the piston 92, when the device is set into operation, some hardener component B is pressed by the channel 13′b into the supplying channel 13b (FIG. 7). The piston 92 is moved forward already before some binder component A is supplied to the mixing chamber 14. During this forward motion the piston 92 is moved into the supplying channel 13b; it simultaneously presses the hardener component A′ which is in the supplying channel 13b in direction X1 into the mixing chamber 14 (FIG. 17) and simultaneously closes the channel 13′b (FIG. 18) so that no hardener component B can flow later out of the store tank 4b and so that some hardener component B which is pressed away by the piston 92 cannot be led off to the channel 13′b. The length of the feed motion of the piston 92 respectively defines the quantity of hardener component B which is in the mixing chamber 14 before the device is set into operation for supplying the binder component A. The binder component A which has been supplied to the mixing chamber 14 then comes already to the hardener component B which is in the mixing chamber. If a small quantity of hardener component B is brought into the mixing chamber by means of the piston 92 of the device 90, the piston 92 is withdrawn from the position shown in FIG. 18 into the position shown in FIG. 17. If the withdrawn position is achieved, the supply of the binder component A and the supply of the hardener component B form both store tanks which receive the hardener component B takes place. since some hardener component B from the respectively preceding mixing processes is still in the supplying channel 13b, some hardener component is always available for the supply of a small quantity of hardener component B in the supplying channel 13b in order to supply a small quantity of hardener component B to the mixing chamber 14 before some binder component A is supplied to the mixing chamber 14. It is possible by means of the device 90 before the big quantity of binder component A is supplied to the mixing chamber 14 that there is already a predetermined quantity of hardener component B in the mixing chamber 14 so that a mixing with the hardener component B already takes place from the beginning. Preferably a quantity of approximately 0.2 gram of hardener component B is pressed or injected into the mixing chamber.

For the embodiment shown in FIG. 19, a plane receiving element 32, for example a spatula, for the material to be mixed C is placed on the base station 2 below the delivery opening 21 of the mixing head 15. The receiving element 32 can be swivelled downwards away from the delivery opening 21 by means of a swivel bearing 33 around an approximately horizontal swivelling axis spaced laterally from the delivery opening 21 against the restoring force of a spring 34 from a rest position into a working position. It can be clearly recognized that during the charging of the receiving element 32 with the material to be mixed C the space between the delivery opening 21 and the receiving element 32 increases because of the weight of the material to be mixed C which is on the receiving element 32. Thus excess rolling actions in the material to be mixed C are avoided on the receiving element 32.

It can be recognized in FIG. 19 that the stator part 16 and the rotor part 19 are positioned rotatable to each other by means of a combined rotation and supporting bearing around a rotational axis. The rotation and supporting bearing has a rotary table 35 on which the rotor part 19 comes to bear with its one front side. The rotor part 19 is connected on its other front side with a shaft which is drivingly connected with the second electric motor 25.

1. Device (1) for blending a binder component (A) and a hardener component (B) to a pasty or liquid material to be mixed, in particular for producing a ready-made filler for the filling of surfaces of vehicle bodies, whereby the device has store tanks (3a, 3b) for the separate storage of the components (A, B) and at least one mixing chamber (14) which is connected by separate supplying channels (13a, 13b) with the single store tanks (3a, 3b), whereby the mixing chamber (14) has at least one delivery opening (21) for the material to be mixed and whereby a metering device is provided for the delivery of the components (A, b) from the store tanks (3a, 3b) through the mixing chamber (14) to the delivery opening (21), wherein the device (1) for the hardener component (B) has at least one store tank (3b) which is connected with the mixing chamber (14) by at least one, preferably by at least one or two separate supplying channels (13b), whereby the supply of the binder component (A) and of the hardener component (B) to the mixing chamber (14) takes place by means of control devices in such a manner that the hardener component (B) is supplied to the mixing chamber (14) with a slight advance with respect to the binder component (A).

2. Device according to claim 1, wherein the device (1) for the hardener component (B) has at least two store tanks (3b) which are connected with the mixing chamber (14) by separate supplying channels (13b).

3. Device according to claim 1, wherein the metering device is configured in such a way that with a bubble free mixing of the components (A, B) the mixing ratio VB:VS from the volume flow VB of the hardener component (B) supplied to the mixing chamber and the sum VS of the volume flow VB and the volume flow VA of the binder component (A) supplied to the mixing chamber is in the range of the 1% to 4%, in particular between 1.5% and 3% and preferably approximately 2%.

4. Device according to claim 1, wherein a thixotrope binder component (A) is placed in the store tank (3a) for the binder component (A) and that the device (1) has a device placed before the mixing chamber (14) for increasing the flowability of the binder component (A).

5. Device according to claim 1, wherein the device for increasing the flowability has at least one element placed in the supplying channel (13a) for the binder component (A) which can be driven in such a way that kinetic energy is brought into the binder component (A).

6. Device according to claim 1, wherein the store tanks (3a, 3b) are placed on a base station (2), that the mixing chamber (14) is formed in a mixing head (15) which can be detachably connected with the base station (2) and that the supplying channels (13a, 13b) are guided and the mixing head (15) configured in such a manner that after the mixing process is terminated and the mixing head (15) separated from the base station (2) all the rests of the material to be mixed remain in the mixing head (15).

7. Device according to claim 1, wherein the supplying channel (3a) for the binder component (A) has an inner and an outer limiting wall which are spaced from each other by an annular gap and are movable with respect to each other in circumferential direction of the annular gap, whereby at least one of these limiting walls as element for bringing in the kinetic energy has a projecting part (22).

8. Device according to claim 1, wherein at least the outer limiting wall is made of a transparent material and that the hardener component (B) differs from the binder component (A) preferably by its color.

9. Device according to claim 1, wherein the elements for bringing in kinetic energy can be placed in several levels spaced from each other in direction of the rotational axis of the motion of revolution by gaps.

10. Device according to claim 1, wherein the planes of extension of at least two levels with elements for bringing in kinetic energy are tilted to each other.

11. Device according to claim 1, wherein the metering device is configured in such a manner that for a bubble free hardener component (B) the quantity of hardener component (B) supplied to the mixing chamber (14) is drawn approximately in equal quantities from the single store tanks (eb) for the hardener component (B).

12. Device according to claim 1, wherein the store tank (3a) for the binder component (A) is preferably placed approximately in the middle between the store tanks (3b) for the hardener component (B).

13. Device according to claim 1, wherein the store tanks (3a, 3b) are configured respectively as cartridges with a sliding bottom (5a, 5b) displaceable in a hollow cylindrical housing section (4a, 4b), that respectively a seat with an abutment (6a, 6b) for the hollow cylindrical housing section (4a, 4b) is provided on the base station (2) for each cartridge and that a pressure piston (7a, 7b) is positioned adjustable respectively to the abutment (6a, 6b) with which a pressure can be charged onto the sliding bottom (5a, 5b) of the concerned cartridge for pressing out the component (A, B) which is therein.

14. Device according to claim 1, wherein the pressure pistons (7a, 7b) are connected by a bridge (9) with each other preferably at their end areas away from the sliding bottoms (5a, 5b) and that the bridge (9) is movable with respect to the abutments (6a, 6b) by means of an actuator.

15. Device according to claim 1, wherein the actuator has a drive shaft which is connected with the bridge (9) for displacing the bridge (9) over a spindle nut (10) placed on a threaded spindle (11).

16. Device according to claim 1, wherein the actuator has an electric motor (12) and that an accumulator is preferably provided for the current supply of the electric motor (12).

17. Device according to claim 1, wherein the actuator has a pneumatic or a hydraulic working cylinder and/or a pneumatic or hydraulic motor.

18. Device according to claim 1, wherein the drive shaft can also be drivingly connected with a handwheel.

19. Device according to claim 1, wherein the drive shaft is drivingly connected with at least one mixing element placed in the mixing chamber (14).

20. Device according to claim 1, wherein the mixing chamber (14) is formed in the type of an annular gap between an inner and an outer chamber wall, whereby the chamber walls are positioned rotatable to each other about a rotational axis and that the mixing elements are teeth (23, 24) placed on the sides of the chamber walls which are turned to each other, teeth to which tooth spaces are adjacent in circumferential direction of the mixing chamber (14) and that the teeth during the motion of rotation rotate past each other by being offset to each other in direction of the rotational axis in such a manner that the components (A, B) are mixed with each other by division.

21. Device according to claim 1, wherein the inner chamber wall and the outer chamber wall are positioned twistable to each other with an axial backlash, that the teeth (24) of the inner chamber wall are offset to the teeth (23) of the outer chamber wall in axial direction in such a manner that front side faces (30, 31) turned to each other, orientated in axial direction, of at least one tooth (24) of the inner chamber wall and of at least one tooth of the outer chamber wall can be positioned against each other by a force acting in axial direction between the inner chamber wall and the outer chamber wall and that these front side faces (30, 31) are inclined with reference to a surface plane placed normal to the rotational axis with an angle (α) such that the front side faces (30, 31) glide on each other during the mixing process without material being removed from the teeth (23, 24) into the material to be mixed (C).

22. Device according to claim 1, wherein additionally to the first electric motor (12) a second electric motor (25) is provided which is drivingly connected with at least one mixing element and that the electric motors (12, 25) are preferably connected with a control device which is configured in such a way that the first electric motor is switched on when switching on or with a time delay after the second electric motor (25) has been switched on.

23. Device according to claim 1, wherein a receiving element (32) for the material to be mixed (C) is placed below the delivery opening (21), this element (32) being movable against a restoring force from a position of rest to a working position in such a manner that it is moved away from the delivery opening (21) when charging with the material to be mixed (C) under the influence of its gravity.

24. Device according to claim 23, wherein the receiving element (32) is connected with the mixing head (15) swivellable from the position of rest into the working position.

25. Device according to claim 1, wherein the metering device can be triggered by a switch clock for mixing a predetermined quantity of the material to be mixed (C).

26. Device according to claim 1, wherein the inner chamber wall is placed on a rotor part (19) and the outer chamber wall on a stator part (16) and that the rotor part (19) is positioned rotatable in the stator part (16) about a rotational axis by means of a rotation bearing and is fixed in axial direction with respect to the stator part (16) by means of a supporting bearing.

27. Device according to claim 1, wherein the supporting bearing has a rotary table (35), rotatable about the rotational axis, on which the rotor part (19) comes to bear with a front side in position of use.

28. Device according to claim 1, wherein a device (90) for the preliminary injection of a small quantity of hardener component (B) is connected with one of the two supplying channels (13a; 13b) for the hardener component (B), this device consisting of a cylinder (91) with one piston placed in its inner space (91a) driven by compressed air or differently, whereby the piston (92) is controllable so that during the supply of a small quantity of hardener component (B) the supplying channel (13a; 13b) for the supply of further quantities of hardener component (B) is closed and after termination of the supply of a small quantity of hardener component (B) the piston (92) introduced in the supplying channel (13a; 13b) is withdrawn from the supplying channel (13a; 13b) and thus the further supply of hardener component (A) into the mixing chamber (14) is released.

29. Device according to claim 1, wherein each store tank (3a, 3b) for the binder component (A) and the hardener component (B) for centering the outlet opening (61) configured in the tank bottom (60) for the container content to the inlet openings of the supplying channels (13a, 13b) in or on its bottom plate (60′) has ring-shaped or partially ring-shaped outwards orientated beads (65) which engage into corresponding groove shaped recesses (75) in the abutment (6a, 6b) configured in the type of a carrier plate for the store tank (3a, 3b), whereby the beads (65) and the groove shaped recesses (75) corresponding with them are configured to each other in such a manner that each store tank (3a, 3b) bears plainly with its tank bottom (60) on the abutment (6a, 6b).

30. Device according to claim 1, wherein each store tank (3a, 3b) for the binder component (A) and the hardener component (B) for centering the outlet opening (61) configured in the tank bottom (60) for the container content to the inlet openings of the supplying channels (13a, 13b) with its bottom sided peripheral marginal bead (80) or peripheral edge border can engage into a ring groove (95) corresponding with this bead and configured in the carrier plate abutment (6a, 6b), whereby the peripheral marginal bead (80) of the store tank (3a, 3b) and the ring groove (95) in the abutment (6a, 6b) are configured to each other so that the store tank (3a, 3b) plainly bears with its bottom plate (60′) on the abutment (6a, 6b).

31. Method for blending a binder component and a hardener component by using a device according to claim 1, wherein the binder component (A) and the hardener component (B) are supplied to a mixing chamber (14) by intercalating a metering device or by excluding a metering device, mixing chamber to which the hardener component (B) is supplied with an advance with respect to the binder component (A).

32. Method according to claim 31, wherein for the advance of the hardener component (B) with respect to the binder component (A) into the mixing chamber (!4) by simultaneously avoiding a further supply of hardener component (B) a small quantity of hardener component (B) is pressed out of the supplying channel (30a; 30b) into the mixing chamber by means of a driven piston (92), whereby the supply of the hardener component (B) and of the binder component (A) takes place after withdrawal of the piston (92) out of the supplying channel (13a; 13b).
